(19) United States
(12) Patent Application Publication
(10) Pub. No.: US 2024/0099171 A1
(43) Pub. Date: Mar. 28, 2024

(54) Turning Plowing Device

(71) Applicant: Huber Soil Solution GmbH, Wagna (AT)

(72) Inventor: Franz-Ferdinand Huber, Wagna (AT)

(21) Appl. No.: 18/274,892

(22) PCT Filed: Jan. 26, 2022
(86) PCT No.: PCT/EP2022/051718

§ 371 Date: Jul. 28, 2023

(30) Foreign Application Priority Data
Feb. 3, 2021 (DE) 10 2021 200 973.5

(51) Int. Cl. A01B 15/16; A01B 15/06

(52) U.S. Cl. CPC A01B 15/16; A01B 15/06

(57) ABSTRACT

A turning plowing device 1 with blade-like cutting elements 3 situated on both sides of a plow beam 2 is provided, in which at least one first cutting element 4 on one side, having a hollow disc-like design, is provided. This first cutting element 4 is swivelably arranged, and may be swiveled from a first position on a first side of the plow beam 2 into a second position. In the first position, the second cutting element 3 is associated with a respective first cutting element 4 in such a way that a complete module made up of these two cutting elements is formed. A row of second cutting elements 3 formed at the plow beam 2 represents semi-modules, which likewise form a complete module only after the respective first cutting elements 4 swivel into the corresponding working position. Plowing takes place only using a formed complete module. For this purpose, after the plowing of a furrow in the first direction, the plow and the first cutting element 4 having a hollow disc-like design are turned in such a way that during back-plowing in a plowing direction 5 opposite the previous direction, plowing may be carried out with identical angles. For this purpose, after the swivel arm 6 together with the first cutting element 4 is swiveled with respect to the cutting element 3 and the turning plowing device is turned by 180°, the plow rotates in a manner of speaking, so that an identical plow pattern may be created in the opposite direction.

### CROSS-REFERENCE TO RELATED APPLICATIONS

This is the US national phase of International Patent Application No. PCT/EP2022/051718, filed Jan. 26, 2022, which claims the priority benefit of German Application No. 10 2021 200 973.5, filed Feb. 3, 2021, the entire contents of each of which hereby being incorporated by reference herein.

### FIELD OF THE DISCLOSURE

The invention relates to a turning plowing device with an arrangement, on one side of the plow beam, of plow modules made up of a hollow disc-like first cutting element and a blade-like second cutting element.

### BACKGROUND

A plowing device for plowing soil is known from DE 10 2017 102 683 B3, in which are provided a carrier structure, a rotatable first cutting element that is situated at the carrier structure and that cuts a side area of a soil ridge of the soil along a plowing direction when the plowing device, and thus the carrier structure, moves, and a second cutting element, which is likewise situated at the carrier structure and which cuts the bed or the base area of a soil ridge. In this known plowing device, the second cutting element runs in front of the first cutting element. The second cutting element is designed as a flat rotatable disc which cuts the bed of the soil ridge, and after which a hollow disc-like second disc, which similarly achieves the cutting of the side area of the soil ridge and its reversal, is situated at the carrier structure of the plowing device. The reversal is also assisted by a moldboard situated after the first cutting element. The advantage of such disc plows is that the traction for this type of plow is much lower than with conventional moldboard plows, so that significant fuel savings may sometimes be achieved. In the plowing of large areas, when it is desired to not leave an embankment or an unplowed region, for example, plowing is generally carried out so that after plowing is completed in one direction, a turn is made at that location and the reverse plow furrow directly adjoins this plow furrow. In the process, the soil ridge must be turned in such a way that it has the same direction as the forward furrow. This is not achievable using a single-row bed plow. Therefore, for the described tasks, so-called turning plows are used which have plow elements on both sides of a plow beam, by means of which a soil ridge may be separated and turned. For this purpose, such a turning plow has a double-row fitting, which means that situated on each side of the plow beam is at least one plow module, preferably multiple plow modules that are joined to form a combination, which in each case is/are made up of two cutting elements. When fairly large land areas are to be plowed in the described manner, the turning plows must therefore plow with one row of the modules, and for the reverse furrow, must turn the plow by 180° and plow the reverse furrow in the turned position. However, this means that the plows can always only operate with one-half of the modules that are present, and one-half must be pulled along in the “idle” state, in a manner of speaking. On the one hand this increases the design complexity for a plow, and on the other hand also increases the mass to be moved, and therefore the traction and thus the fuel consumption. A further disadvantage of this known plowing device is that the two cutting elements associated in each case for the plowing task are each fastened individually to a carrier structure at the plow beam, so that adjusting them to one another involves a relatively great effort.

DE 10 2019 204 256 A1 describes a plow module or a plowing device having these types of plow modules, in which in each case first cutting element having a hollow disc-like design and a flat second cutting element, following in the plowing direction, are provided. A side area of a soil ridge is cut with the first cutting element, and a base area of a soil ridge is cut with the second cutting element. Both cutting elements, in the form of a plate-like cutting element in each case, are connected to one another in a carrier structure, and via this carrier structure may be adjusted with regard to their angles relative to one another and with regard to the angles with respect to the soil ridge to be cut. Since both cutting elements are mounted on a carrier structure, and this carrier structure is mounted on the plow beam, in the event of changing soil conditions or damage during plowing, such a plow module may be quickly detached from the plow beam and replaced by a new one, so that even for damaged cutting elements the entire plowing device may be quickly reused for plowing, without long pauses. Instead of the disc-shaped cutting element, for this purpose an angled blade may also be present, so that, depending on its setting with an appropriate force, with regard to the setting angle it may be moved into or out of the ground to be plowed. When a turning plow is used, the modules must then be mounted on both sides of the plow beam so that when the plow beam is turned by 180°, the modules are brought into an engaged position with the soil in such a way that for the reverse furrow, the turning of the soil ridge takes place in the same direction as for the forward furrow before the turning plow turns from the first position into the second position.

Furthermore, a plow module having a perforated plate is known from DE 10 2019 217 245 A1, including a first cutting element having a hollow disc-like design for cutting a side area of a soil ridge, and also a second cutting element having a blade-like design for cutting a furrow bed of a base area. By means of the perforated plate, the respective cutting elements may be adjusted to different soils, different plowing depths, and also different types of soil. A double-row arrangement of the plow modules at a plow beam is also provided with this known plowing device, so that furrows to be plowed may be placed directly next to one another, and after the soil ridge is turned, the turned soil ridge may be placed in the same way for the reverse trip as for the forward trip.

Compared to the known disc plows having two cutting elements, the object of the present invention is to provide a turning plowing device that transfers the advantages of a bed plow with a single-row disc fitting to the functionality of a turning plow.

### GENERAL DESCRIPTION

According to the invention, the turning plowing device has blade-like cutting elements situated on both sides of a plow beam. These are also referred to as undercutting tools or angled blades, and are fixedly mounted on the plow beam, in particular on both sides of the plow beam, i.e., situated at 180° relative to one another. These blade-like cutting elements are preferably variably adjustable with regard to their setting angle, for example. The adjustment may preferably be controlled hydraulically, in particular from the driver's cab. The setting angle results in a penetration depth control, which preferably takes place via hydraulic actuators. The setting angle of these blade-like cutting elements ultimately defines the force with which the plowing device is drawn into the ground, and thus, the adjustment of the plowing depth. According to the invention, at least one first cutting element on one side relative to the plow beam, and having a hollow disc-like design is now provided, which is swiveled from a first position on a first side of the plow beam, in which the first cutting element is situated with respect to the blade-like second cutting elements, in such a way that in each case a second cutting element and the first cutting element in the first position together form a complete module for plowing in a plowing direction, into a second position, on a second side opposite from the first side of the plow beam, by means of a swivel arm. When the first cutting element is swiveled from the first position into the second position, the second cutting element in the second position, which in a manner of speaking represents a semi-module, together with the first cutting element forms a complete module.

The essential core of the invention is that the blade-like second cutting elements are situated on both sides, i.e., 180° opposite one another on the plow beam, and the first cutting element is swivelable from the first position into the second position opposite thereto. Whenever the first cutting element is in one of the positions, i.e., the first position or the second position, the first cutting element together with the respective second cutting element in each case forms a complete module made up of the first cutting element having a hollow disc-like design, and the second cutting element preferably having a blade-like design. When the first cutting element is swiveled to the first position, the complete module which is then present there may be used for plowing the ground in a first direction. At the end of the furrow, the towing vehicle may turn and plow the second furrow directly next to this furrow in the reverse direction. This only requires that the first cutting element be swiveled from the first position into the second position, so that for the furrow in the opposite direction, it may be plowed with the same camber angle and setting angle of the first cutting element having a hollow disc-like design. By swiveling the first cutting element around from the first position into the second position, it is thus possible to make a half-row plow, which represents a bed plow in a manner of speaking, into a turning plowing device.

In contrast to a conventional turning plow, in which a row of plow modules must always be carried along in the idle state while the first furrow is being plowed, at least one first cutting element having a hollow disc-like design is thus saved. The more plow modules that are fastened to the plow beam, the greater the savings. This results in a significant decrease in the complexity of the turning plowing device compared to a conventional device of this type. Due to the lower mass, traction and thus also fuel for the towing vehicle are saved. The swiveling of the first cutting element from the first position into the second position and vice versa takes place via a swivel arm. At the plow beam, the first cutting elements having a hollow disc-like design are connected via corresponding swivel axes to a swivel arm that is supported at the plow beam so as to be vertically rotatable or swivelable. The swivel axes are preferably arranged at the plow beam in such a way that the swivel arm is vertically swivelable in a predefined range. By combining a second cutting element or a row of second cutting elements, a complete module is created in each case. The first cutting elements having a hollow disc-like design together with the swivel arm mechanism describe a defined trajectory on their swivel path, and in the end position, i.e., in the respective first or second position, are combined with the undercutting tool to form a functional module assembly.

In an arrangement of multiple hollow disc-like first cutting elements, these are preferably connected to one another via a rod assembly, and at the same time are swivelable from the first position into the second position by means of the respective swivel arm.

However, it is also possible for multiple hollow disc-like first cutting elements to be individually swivelable by equal angles from the first position into the second position by means of respective hydraulic cylinders. The cutting angle for the first cutting elements having a hollow disc-like design is set in a horizontal position, in particular parallel to the plow beam. In contrast, the camber angle is set in the course of the swivel operation over the swivel range, for example in the range of 0° to 80°, relative to the horizontal starting position complementary thereto. The working position for cutting angles and camber angles is thus reached without subsequent correction of the hollow disc-like cutting element (camber angle), and without the need for an additional swivel axis for adjusting these angles.

The first cutting element is preferably provided for cutting a side area of a soil ridge from the soil, while the second cutting element cuts the base area of the soil ridge, i.e., its bed, in the plowing direction. The first cutting element preferably has the same cutting angle and camber angle in each case, compared to the previous position, after the swiveling into the first position and also after the swiveling into the second position. For turning the turning plowing device, the plow beam is rotated by 180° about a plow tower turning unit. The camber angle continuously changes during the swiveling. During swiveling of the swivel arm from the first position into the second position or vice versa, the camber angle and the cutting angle may be equal, for example approximately 77°, in particular 77.3°. If, for example, the swivel arm position of 77.3° is not yet reached, this results in a larger cutting angle, and for swiveling by greater than 77.3°, the camber angle becomes larger. Within the swivel range of the swivel arm from 0° toward 90°, the first cutting element having a hollow disc-like design experiences, in a manner of speaking, a rotation in space relative to the swivel plane. In the course of the swivel movement, the cutting angle and camber angle of the two cutting elements are thus continuously changed with respect to the pull line of the tractor or the furrow wall. It is thus preferably possible to regulate a desired soil tillage intensity. For example, if the soil is to be cut more (initial cut) or turned more, this is possible, depending on the position of the swivel arm. It is understood that the swivel arms for the first cutting elements having a hollow disc-like design are lockable in a desired position.

The second cutting elements having a blade-like design are preferably adjustable at the plow beam, for example by means of a perforated plate, and also with regard to their setting angle for penetration depth control, using hydraulic actuators. In any case, the blade-like second cutting elements are fastened to the plow beam.

It is further preferred that the blade-like second cutting elements are mechanically adjustable at the plow beam and with regard to their setting angle for penetration depth control, in particular preferably via a perforated plate with shear bolts. At the same time, the caster stability may preferably be improved across the perforated plate width. The inclination-adjustable perforated plate is adjustable via the perforation; i.e., the penetration depth is thereby adjustable. In addition, protection from stones may be achieved with the simple locking via a shear bolt.

The swivel elements are preferably swivelable in a first swivel direction by 270° to 300° about the swivel axis, or in a second swivel direction opposite the first swivel direction are swivelable by 80° to 100°, the swivel axis being situated at 90° with respect to the pull line of the plowing device. The hollow disc-like first cutting elements are preferably swivelable in a plane, which is preferably achievable via a swivel lever, which at the same time is fixable for locking in the end position, i.e., the first position or the second position.

According to a further preferred embodiment, a second cutting element is situated behind only every other first cutting element. This likewise saves on costs, since the overall structure of the turning plowing device according to the invention has a simpler design with fewer components.

By use of the turning plowing device according to the invention, during plowing it is thus possible to avoid the undesirable so-called converging, which conceptually stands for embankment formation, or diverging, which characterizes empty furrows, of a bed plow. The turning plow according to the invention, which may also be referred to as a reversible plow, has been developed primarily for avoiding converging and diverging. However, the disadvantage of this turning plow is that a double fitting of the blade-like second cutting elements, namely, on both sides of the plow beam, is required.

The core of the present invention, i.e., of the turning plowing device, is that double fitting with complete modules is not necessary; only the second cutting elements having a blade-like design have double fittings. Due to the fact that the hollow disc-like first cutting elements between the first position, the first side of the plow beam at which the blade-like second cutting elements are situated, may be swiveled into the second position, 180° opposite the first position, and in the particular position, together with the blade-like second cutting elements form a complete module, it is possible to avoid both converging and diverging without the need for complete modules on both sides of the plow beam.

When the field boundary is reached at the end of a field to be plowed, the plowing device is still in the working position, with a cutting angle and camber angle that are set exactly for this plow. At the end of the field, at the end of the furrow the plowing device is hydraulically lifted from the furrow, and is subsequently rotated by 180° about the horizontal axis via the turning unit, which is equipped with a vertical shaft. In the process the disc row, i.e., the hollow disc-like first cutting elements, is/are swiveled onto the opposite side, i.e., upwardly. The discs are subsequently swiveled concurrently into the working position, hydraulically or via a coupling rod mechanism, so that for the return trip the same angle conditions prevail for the camber and the cutting, so that neither embankment formation nor empty furrows result. This means that the system is easily mirrored, and cutting and camber angle settings are retained. After the swivel operation in question, a complete module is once again established on the opposite side, and after the swivel operation is completed the hollow disc-like first cutting elements are locked in the working position then present. The camber angles and cutting angles are then once again identical to those for the forward trip.

These novel kinematics according to the invention allow the functionality of a turning plow to be easily provided from a bed plow having a single-row disc fitting.

Improved mechanical weed control is achieved by the second cutting elements and the undercutting tools having a blade-like design, which results in decreased use of chemical herbicides. The turning plowing device according to the invention also results in better soil loosening and better intermixing due to the rotating hollow disc-shaped first cutting elements, i.e., the hollow discs. Since the ground coverage rate is controllable during plowing, a direct positive impact may also be made on the water balance and erosion protection. More space for root growth of the plants results due to the fact that gentle turning with the creation of a higher pore volume is possible using the plowing device according to the invention. The improved lower drag resistance compared to conventional moldboard plows results in fuel savings and thus also in CO2 reduction, which as a whole promotes environmental sustainability and results in overall increased yield and soil improvement.

### BRIEF DESCRIPTION OF THE DRAWINGS

Further advantages, features, and application options of the invention are now explained based on exemplary embodiments, with reference to the appended drawings. In the drawings:

FIG. 1 shows a first exemplary embodiment of the turning plowing device according to the invention, with hollow disc-shaped cutting elements that are swivelably connected via a rod assembly;

FIG. 2 shows a second exemplary embodiment, with hollow disc-like cutting that are individually swivelably arranged via hydraulic cylinders;

FIG. 3 shows a side view of the exemplary embodiment according to FIG. 1, with swiveling of the hollow disc-shaped cutting elements from their first position into the second position;

FIG. 4 shows a basic representation of a hollow disc-like cutting element that is swivelably arranged at the plow beam by means of a hydraulic cylinder;

FIG. 5 shows a basic arrangement of the hollow disc-like cutting element according to FIG. 4, but with the hydraulic cylinder extended for swiveling;

FIG. 6 shows a basic three-dimensional representation of the exemplary embodiment according to FIG. 2, but with the first cutting elements omitted to simplify the illustration;

FIG. 7 shows a basic representation of the arrangement of the hollow disc-like cutting element, with adjustment via a hydraulic cylinder and with a cutting angle that is adjustable via a perforated plate;

FIGS. 8a), b), c) show the basic representation of the exemplary embodiment according to FIG. 2 in three views, with various phases of the swiveling of the hollow disc-like cutting elements, which takes place by means of the hydraulic cylinder, with the second cutting elements omitted in the drawing;

FIG. 9 shows a view of the turning plowing device according to the invention, viewed in the direction of the pull line for a swiveling option of the hollow disc-like cutting elements according to the first exemplary embodiment, with the second cutting elements omitted in the drawing;

FIG. 10a) shows two views of a hollow disc-like cutting element according to the exemplary embodiment according to FIG. 2 in its working position, in a side view and in a top view;

FIG. 10b) shows a hollow disc-like cutting element according to the second exemplary embodiment in the neutral position;

FIG. 11 shows a further exemplary embodiment with two hollow disc-like cutting elements arranged one behind the other, with which a single first cutting element is associated; and

FIG. 12 shows a commercially available duckfoot tine which is provided instead of the second cutting element shown in FIG. 11, with cutting blades extending in two directions.

### DETAILED DESCRIPTION

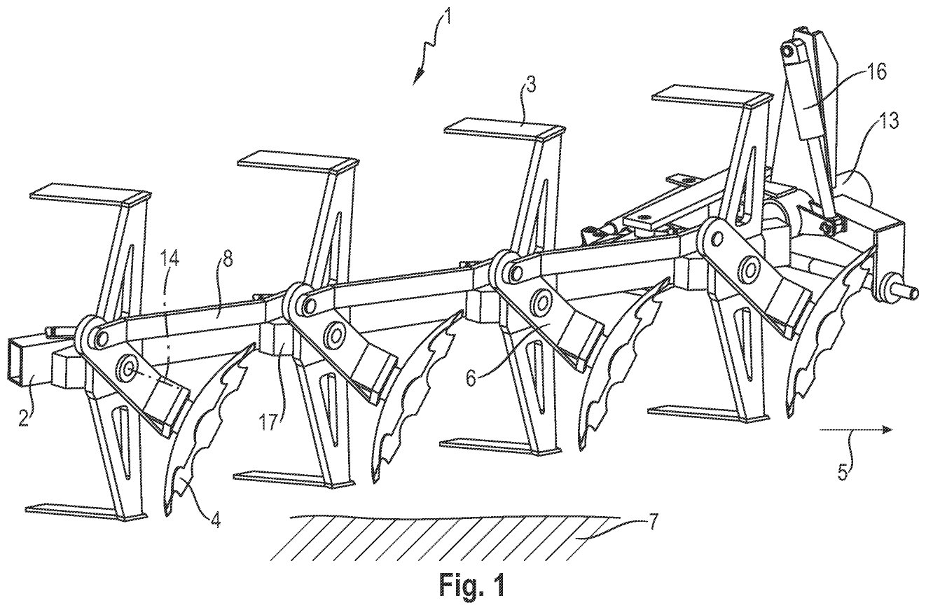

FIG. 1 shows a turning plowing device 1 according to the invention according to a first exemplary embodiment. Provided at the plow beam 2 on both sides, i.e., directed upwardly and downwardly, are four blade-like second cutting elements 3, also referred to as semi-modules, since a second cutting element 4 is not permanently associated with them.

The turning plowing device 1 is connected to a towing vehicle via a plow tower turning unit 13, and is pulled by the towing vehicle in the plowing direction 5, indicated by the arrow in the drawing, below the plow tower turning unit 13. The plow tower turning unit also drives the rod assembly 8, which during a pulling or pushing movement swivels the hollow disc-like first cutting element 4, by means of a swivel arm 6, about a swivel axis 14 from a first position, which in the illustrated example is the working position of the turning plowing device 1, into a second position, not illustrated. In the first position, the hollow disc-like first cutting element 4 thus makes a particular blade-like second cutting element 3 into a complete module from a semi-module. When the swivel arm 6 swivels the hollow disc-like first cutting element 4 about the swivel axis 14 and into the second position by moving the rod assembly 8, according to the illustration in FIG. 1 the particular upper blade-like second cutting element 3, together with the hollow disc-like first cutting element 4 that is swiveled into the second position, is likewise made into a complete module from a semi-module.

This means that the turning plowing device 1 according to the invention, in contrast to a normal turning plow with complete modules extending at both sides of the plow beam, merely has a simple arrangement of hollow disc-like first cutting elements 4, which is always swiveled with respect to the row of blade-like second cutting elements 3 that is provided specifically for plowing. The double-row arrangement of first and second cutting elements 3, 4 on both sides of the plow beam 2, which is common for a conventional turning plow, is thus dispensed with. It is thus possible to achieve significant material and weight savings for the turning plowing device 1 according to the invention compared to conventional plows, so that for this reason as well, a lighter plow also requires less traction. This also entails further fuel savings as well as CO₂ reductions. The overall environmental balance of this type of plow is therefore greatly improved over conventional turning plows, especially conventional moldboard plows.

The turning plowing device 1 illustrated in FIG. 1 is shown in a position in which it is still above the ground 7 to be plowed, which is indicated schematically. The plow beam 2 is swiveled out of the pull line in the pulling direction by a so-called bar angle. The respective swivel arm 6 for the particular hollow disc-like first cutting element 4 is supported on the plow beam 2 by means of a bearing block 17, which is provided via an inclined plane, so that the angle of the hollow disc-like first cutting element 4 is in each case optimally adjusted to the pull line. For carrying out the turning of the turning plowing device 1, provided at the plow tower turning unit 13 is a turning hydraulic cylinder 16 by means of which the plow modules are rotated by 180°, so that the row of blade-like second cutting elements 3 illustrated in FIG. 1, situated at the plow beam 2 at the top, may be swiveled downwardly and pointing to the ground 7, and the hollow disc-like first cutting elements 4 are subsequently swiveled with respect to the blade-like second cutting elements 3 pointing toward the ground 7, via the rod assembly 8.

In the exemplary embodiment shown in FIG. 1, the blade-like second cutting elements 3, referred to as undercutting tools, are fixedly mounted. However, they are variably adjustable by means of perforated discs, not illustrated, to allow, for example, their setting angle and thus the soil penetration force to be adjusted, in particular as a function of different soil qualities.

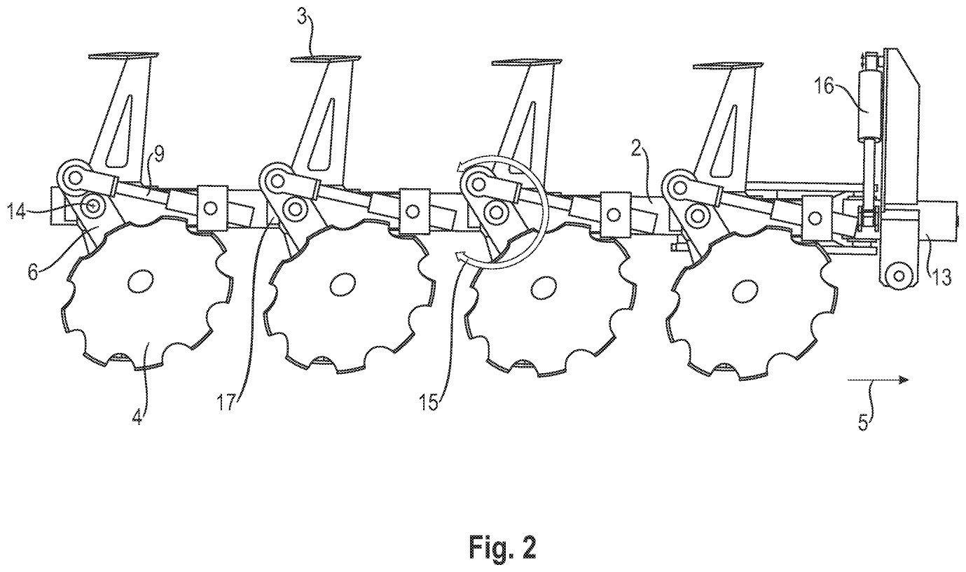

FIG. 2 shows a second exemplary embodiment that basically corresponds to the design from FIG. 1, except that instead of a rod assembly in the exemplary embodiment according to FIG. 1, [in] the turning plowing device 1 according to the second exemplary embodiment according to FIG. 2, for each individual hollow disc-like first cutting element 4 a hydraulic cylinder 9 is provided as an actuator for swiveling the first cutting element from 35 the first position into the second position. From the illustrated first position, which according to FIG. 2 is the working position, and in which the first cutting element 4 together with the second cutting element 3 forms a respective complete module, swiveling individually takes place into the second working position, so that the upper row of second cutting elements 3, illustrated in the drawing, together with the first cutting element 4 once again form complete modules, which are swiveled into this working position by swiveling the turning plowing device 1 via the plow tower turning unit 13 by means of a corresponding turning hydraulic cylinder 16 when, for example, the turning plowing device 1, after plowing a furrow in the plowing direction 5, is to be turned for the furrow in the opposite direction. This swiveling of the hollow disc-like first cutting element 4 is achieved via the respective hydraulic cylinders 9 within the scope of the swivel range 15 illustrated by the circular double arrow. The hydraulic cylinders 9 associated with the respective first cutting elements 4 may be individually swiveled; however, before starting the plowing they must be coordinated with one another so that they operate with the same camber angle and cutting angle settings. The individual hydraulic cylinders 9 are therefore preferably synchronized with one another with regard to their function that achieves the swiveling of the first cutting element 4.

The hollow disc-like first cutting elements are thus vertically rotatably supported via the respective swivel arms 6. In a predefined area, the swivel axes at the plow beam 2 are now situated in such a way that the swivel arm 6 is vertically swivelable. The hollow disc-like first cutting elements 4 with their respective swivel arm mechanism thus describe a defined swivel path during swiveling, and at a defined position, i.e., the first position or the second position, relative to the undercutting tool, i.e., the blade-like second cutting element 3, are combined to form a functional module assembly, i.e., a complete module. The cutting angles 24 necessary for the hollow disc-like first cutting elements 4 are set in a horizontal position, a so-called neutral position, parallel to the plow beam 2. The camber angle of the respective hollow disc-like first cutting elements 4 is set in the course of the swivel operation over the swivel range 15 of 0° to 80°, for example, in particular relative to the horizontal starting position complementary thereto.

A significant advantage of the invention is that the working position with regard to the cutting angle and camber angle may be reached without subsequent correction of the disc angle (camber angle). It is thus possible to dispense with an additional swivel axis for setting correct cutting angles and camber angles. The designs and functions of the other components, denoted by the corresponding reference numerals, correspond to those already discussed in the description of FIG. 1, and therefore are not repeated here.

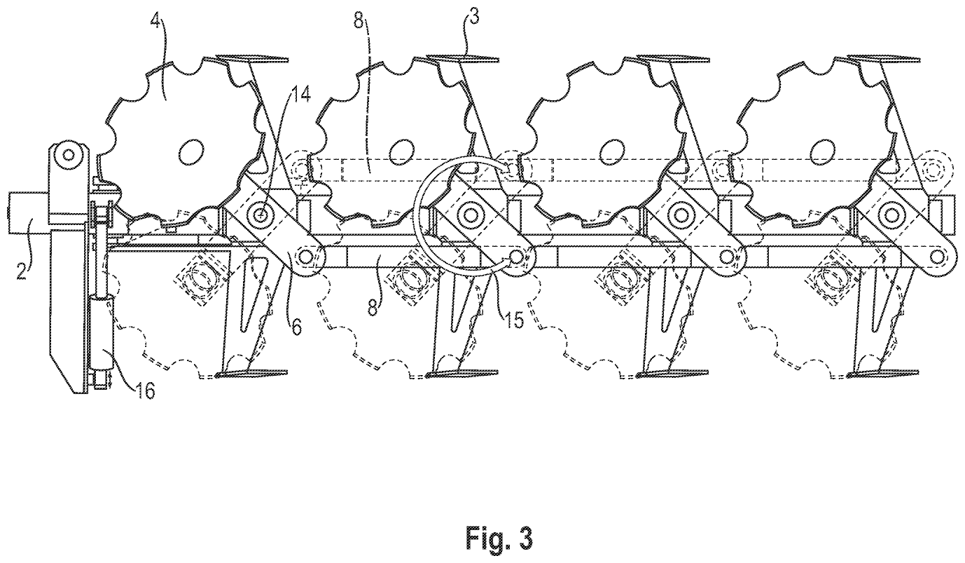

FIG. 3 illustrates the exemplary embodiment according to FIG. 1 in which, however, starting from the first position, i.e., a first working position, via swiveling about the swivel range 15 the hollow disc-like first cutting elements 4 are swiveled into the second position in which, together with the second, upper row of blade-like second cutting elements 3 in the position then swiveled into, once again form a respective complete module. The swiveling into the second position is denoted by swivel arms 6 depicted by dashed lines. The rod assembly 8 during swiveling of the first cutting element 4 into this second position is likewise illustrated by dashed lines. The basic design and function correspond to those in the exemplary embodiment according to FIGS. 1 and 2; according to FIG. 2, instead of the rod assembly a respective hydraulic cylinder 9 is situated at each hollow disc-like first cutting element 4 or its swivel arm 6.

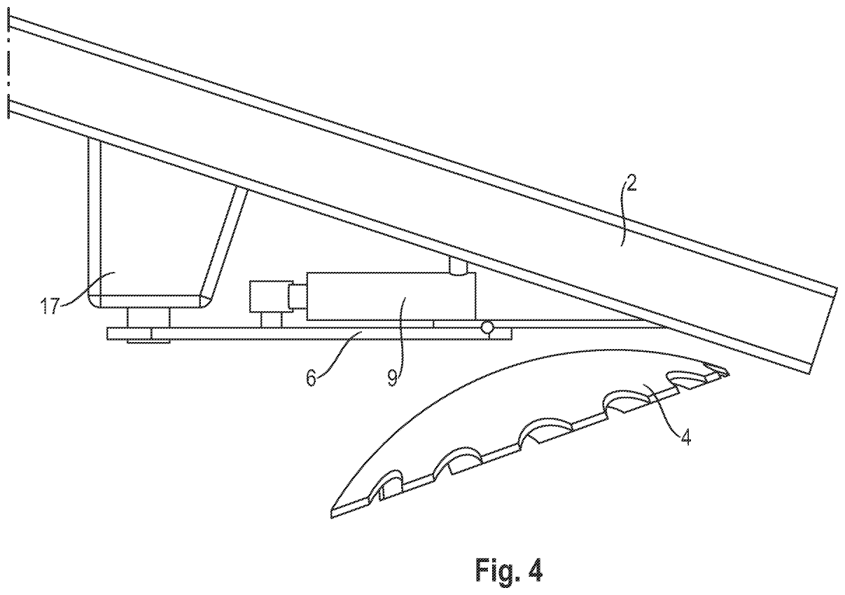

FIG. 4 illustrates a detail of the basic arrangement of the hollow disc-like first cutting element 4, together with the inclination of the rotational axis of the first cutting element or the deflection of the plow beam 2 with regard to the pulling direction. For this purpose, the bearing for the swivel arm 6 is swivelable for swiveling the first cutting element 4 from the first position into the second position, i.e., from a first working position for a forward furrow into the second working position, including the turning of the turning plowing device 1 for the reverse furrow. For this purpose, the bearing block 17 has the corresponding inclination of the plow beam 2 of approximately 20°, as illustrated. The adjustment of the swivel arm 6 for swiveling the first cutting element 4 from the first position takes place using the hydraulic cylinder 9. The swivel arm 6 in its longitudinal orientation is aligned in parallel with the pulling direction, so that during swiveling of the hollow disc-like first cutting element 4 it is moved in a plane in which the swivel movement of the swivel arm 6 lies.

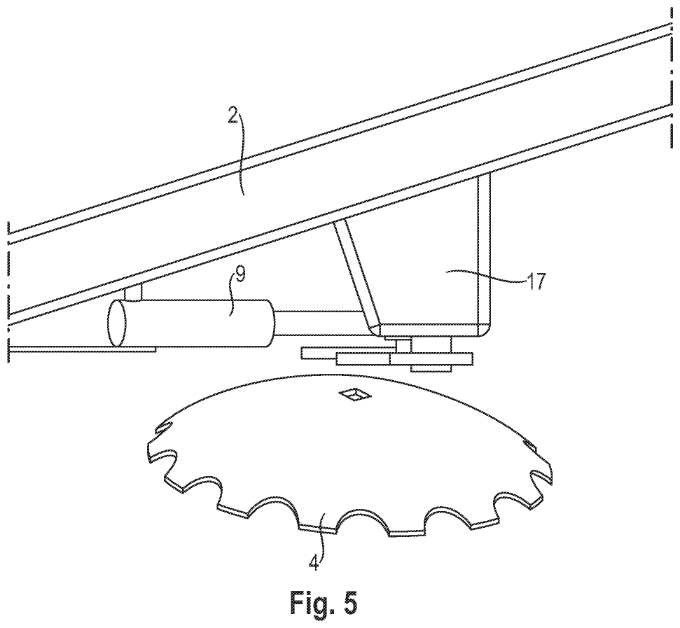

FIG. 5 shows the exemplary embodiment according to FIG. 2, i.e., with a hydraulic cylinder 9 for achieving the swivel movement of the hollow disc-like first cutting element 4. It is illustrated in FIG. 5 that the hydraulic cylinder 9 is extended compared to the illustration according to FIG. 4; i.e., the first cutting element 4 has been swiveled into the second working position, opposite the first working position. In addition, it is illustrated in FIG. 5 that the hollow disc-like first cutting element 4 not only has a defined cutting angle, but is also set to a defined camber angle.

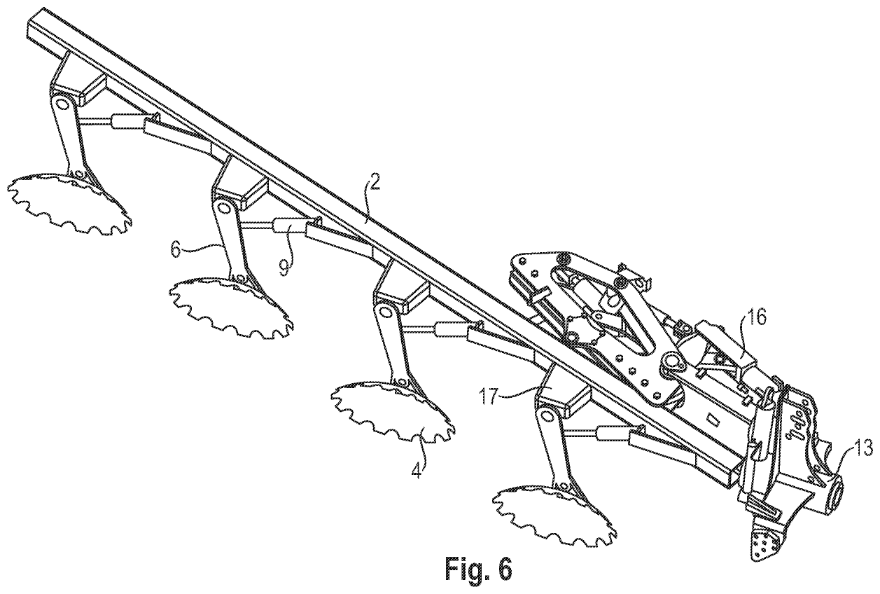

FIG. 6 shows a three-dimensional illustration of the exemplary embodiment according to FIG. 2, namely, with an adjustment of the swivel arms 6 for the hollow disc-like first cutting elements 4 by means of respective hydraulic cylinders 9. This means that each swivel arm 6 of the hollow disc-like first cutting elements 4 is connected to a hydraulic cylinder 9, which on one side is fastened to the swivel arm 6, and on the opposite side is fastened to the plow beam 2. Situated at the end of the turning plowing device 1 on the vehicle side is a plow tower turning unit 13, by means of which the turning plowing device 1 is rotatable by 180° via a hydraulic actuator 16 when a reverse furrow is to be plowed, so that a uniform plow pattern occurs, not an embankment formation or an empty furrow. The blade-like second cutting elements 3 are omitted in the illustration for the sake of simplicity. Depending on the swivel position, i.e., whether the particular hollow disc-like first cutting elements 4 are in the first working position or in the second working position, according to their swivel position, either from the semi-module of the lower row of blade-like second cutting elements 3 or the top row of these second cutting elements 3, together with the first cutting element 4 make a complete module. Therefore, in contrast to the requirement with a conventional turning plow, only one set of hollow disc-like first cutting elements 4 is provided, which is swivelable with respect to the respective second cutting elements 3, and after swiveling has taken place, in each case then creates a complete module from a semi-module. In order for the plane in which the swivel arms 6 rotate during their swiveling to be parallel to the pulling direction, each swivel arm 6 with its swivel axis is fastened to a bearing block 17 that is articulated at the plow beam 2 and that has a bevel whose angle is identical to the deflection of the plow beam 2 with respect to the pulling direction.

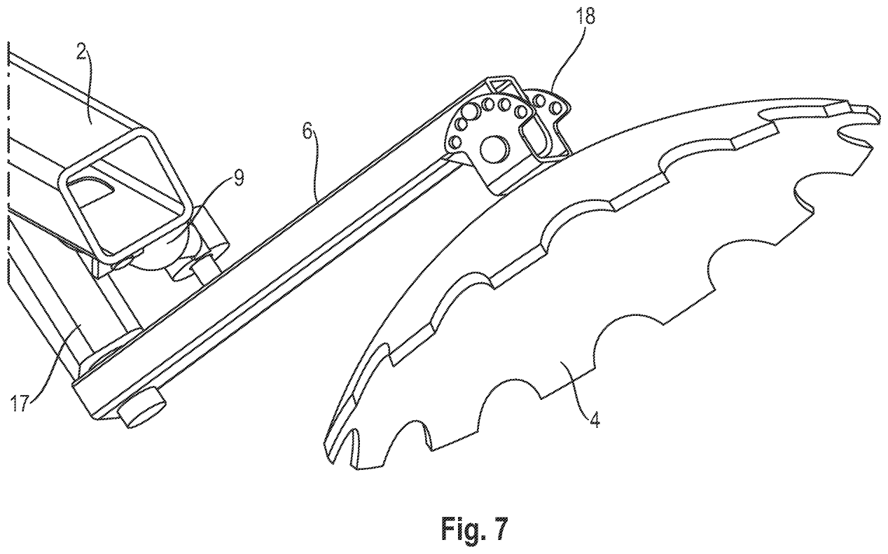

FIG. 7 shows a basic illustration of an arrangement of the hollow disc-like first cutting element 4 at the turning plow device 1. The swiveling of the hollow disc-like first cutting element 4 takes place via a hydraulic cylinder 9 according to the second exemplary embodiment (see FIG. 2). The swivel arm 6 at one end is connected to the bearing block 17, via which the swivel axis is achieved. The hydraulic cylinder 9, which at its opposite end is connected to the plow beam 2, is fastened between the swivel axis 14, situated at one end of the swivel arm 6, and the mounting of the hollow disc-like first cutting element 4 at its other end. A perforated plate element 18 for additional adjustment of the cutting angle 24 of the first cutting element 4 is provided at the end of the swivel arm 6 to which the hollow disc-like first cutting element 4 is fastened. The adjustment of the cutting angle 24 to changed soil conditions, for example, may be made by fastening a bolt into holes in the perforated plate which achieve a particular swivel angle.

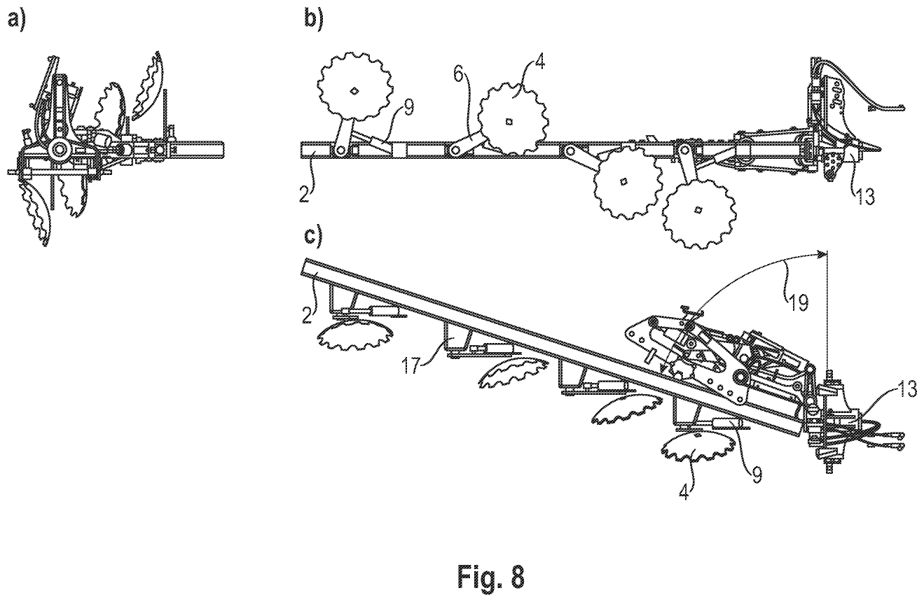

FIG. 8 shows a view opposite the pulling direction (a), a side view (b), and a top view (c) according to the three-dimensional illustration in FIG. 6. Here as well, the blade-like second cutting elements 3, which based on the illustration according to FIG. 8b) are situated at the top side and at the bottom side of the plow beam 2, are not shown in the illustration for the sake of simplicity. The intent of the three different views according to FIG. 8 is to clarify which individual phases are swiveled during swiveling of a hollow disc-like first cutting element 4 from the first working position, i.e., the plowing position (see FIG. 8b), first cutting element on the right), in which the first cutting element 4 together with the second cutting element, not illustrated, forms a complete module, via the various intermediate positions to the second position (see FIG. 8b), far left). In the second position, the hollow disc-like first cutting element 4 together with the blade-like second cutting element 3, not illustrated, once again forms a complete module. The individual illustrated swivel phases conceptually relate to a single first cutting element. Of course, the individual positions, including the intermediate positions, do not relate to adjustment positions of the hollow disc-like first cutting element 4 at the turning plowing device 1. Rather, the individual first cutting elements 4 must be situated in their respective working positions in such a way that for purposes of plowing they form, together with the respective second cutting element 3, a complete module. FIG. 8c) illustrates a top view of the various intermediate positions of the turning plowing device 1. FIG. 8a) illustrates a viewing direction opposite the pull line, and once again shows the various positions of the hollow disc-like first cutting element 4 during swiveling from the working position, i.e., the first position, into the second position, from which the turning plowing device 1 must still be rotated by 180° by means of the plow tower turning unit 13 so that the complete module, formed by the first and second cutting elements, may plow the reverse furrow in the ground. Also depicted in FIG. 8c) is the bar angle 19, which represents the complementary angle for deflecting the plow beam 2 with respect to the pulling direction 5 (not depicted).

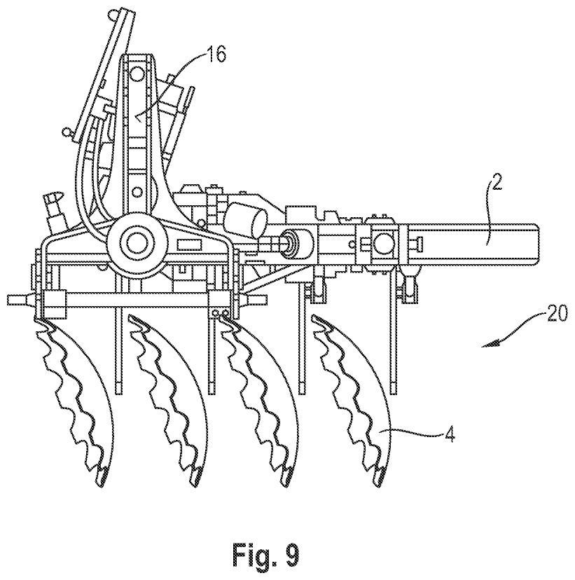

FIG. 9 illustrates a basic view as in FIG. 8a), except with all hollow disc-like first cutting elements 4 in the respective working position, i.e., in the plowing position; in this view as well, the blade-like second cutting elements 3 are not depicted in the illustration for the sake of simplicity.

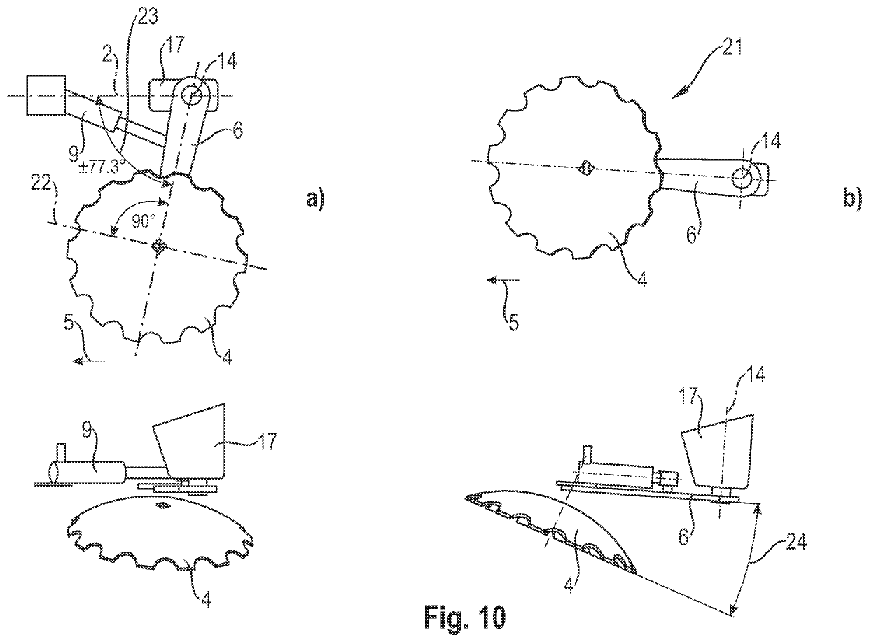

FIGS. 10a), b) illustrate in both a side view and a top view basic angle positions for adjusting and also ensuring the same camber angles and cutting angles of the hollow disc-like first cutting element 4 to be swiveled via a swivel arm 6 by means of a hydraulic cylinder 9. The side view illustrated at the top in FIG. 10a) shows how the hollow disc-like first cutting element 4 is fastened, via a swivel arm 6 by means of a hydraulic cylinder 9, to the swivel arm 6 and to the plow beam 2, which is schematically illustrated only as a dash-dotted line. The swivel arm 6 is connected to the bearing block 17 via the swivel axis 14. During swiveling, which is brought about by the hydraulic cylinder 9, the hollow disc-like first cutting element 4 is brought into the particular position about its swivel axis 14. The plowing direction or pull line 5 is also depicted. For the axis that is inclined forward in the plowing direction, the adjustment axis 22 perpendicular thereto is likewise depicted. The top view of the arrangement is shown at the bottom of FIG. 10a). The relationship of the angular changes of the so-called cutting turning angle (camber angle) during rotation of the swivel arm 6 from 0° (horizontal) to 90° (vertical) is important for understanding the turning plowing device 1 according to the invention. In the starting position of the swivel arm at 0° (horizontal), the cutting angle may be set to 20° , for example. The complementary turning angle (the camber is 0° , i.e., vertical) results when the swivel arm 6 together with the first cutting element 4 is swiveled toward 90° . The camber angle then increases, and the turning angle decreases. There is an angle for which both angles (cutting angle and camber angle) are equal; in the range before reaching 77.3° the cutting angle predominates, whereas after an angle of 77.3° the camber angle predominates. This angle of ±77.3° is also referred to as the plow beam angle 23. For example, when in the horizontal starting position the cutting angle is 20° relative to the pull line of the tractor, the camber angle is 0°. With an increasing swivel direction toward 80°, this complementarily results in an increasing camber angle and a decreasing cutting angle, since the two angles mutually define one another.

The swivel axes 14 for the swivel arms 6 together with the hollow disc-like first cutting elements are mounted or oriented at 90°, i.e., perpendicular to the pull line, corresponding to the travel direction of the towing vehicle. Thus, the orientation of the hollow disc to a 20° cutting angle, for example, has to be carried out only once. The adjustment axis 22 is used only for the adjustment for the same cutting angle and camber angle on both sides.

FIG. 10b) shows the neutral position with regard to the depicted travel direction that is adjusted; i.e., the swiveling of the first cutting elements 4 is interrupted between the first working position and the second working position approximately in the middle, namely, approximately along the orientation of the plow beam 2, which takes place during the actual turning operation. The inclination of the hollow disc-like first cutting element 4 with respect to the swivel arms 6, oriented in parallel to the pulling direction, is shown as a cutting angle 24 in the top view of the illustration according to FIG. 10b).

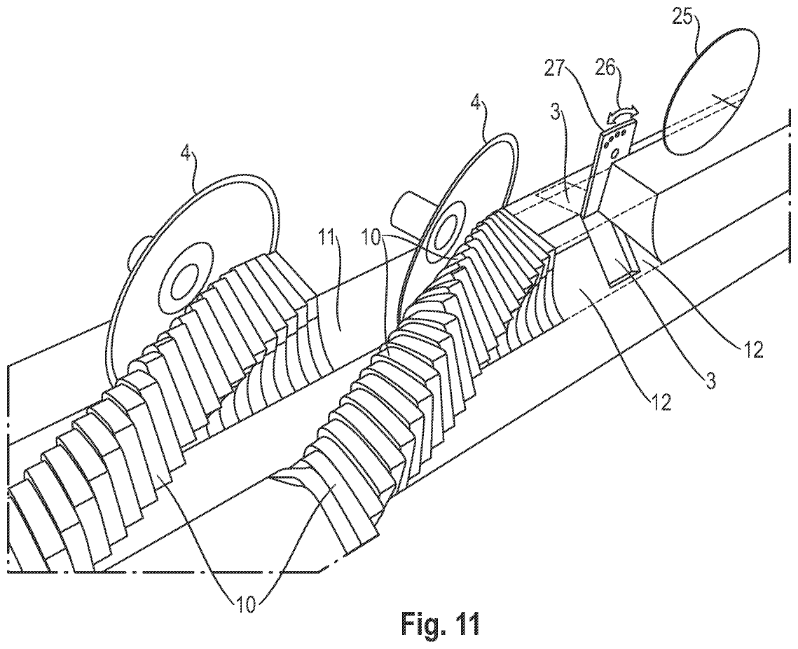

FIG. 11 shows a basic representation of a further exemplary embodiment in which for further reduction of the number of elements required for plowing, two hollow disc-like first cutting elements 4 are situated one behind the other in the plowing direction 5, with which a single blade-like second cutting element 3 is associated, the design of which includes two blade-like partial cutting elements that allow an adjustment 26 of the setting angle by an adjustable perpendicular plate, in particular by means of a perforated plate 27. Cutting may thus be carried out from a middle position on both sides of the base area 12 of the soil ridge 10 for the particular two hollow disc-like first cutting elements 3, situated one behind the other and preceding the blade-like second cutting elements 3 in this design. Both hollow disc-like cutting elements 3 separate the soil ridge from its side area 11, and due to their hollow disc-like design, at the same time bring about turning of the soil ridge. For caster stabilization, a disc coulter 25 is additionally provided after the blade-like second cutting element 3 in the plowing direction 5. This cutting element 3, also referred to as a two-winged blade-like second cutting element 3, which in a manner of speaking serves as two leading hollow disc-like first cutting elements, would have to manufactured separately.

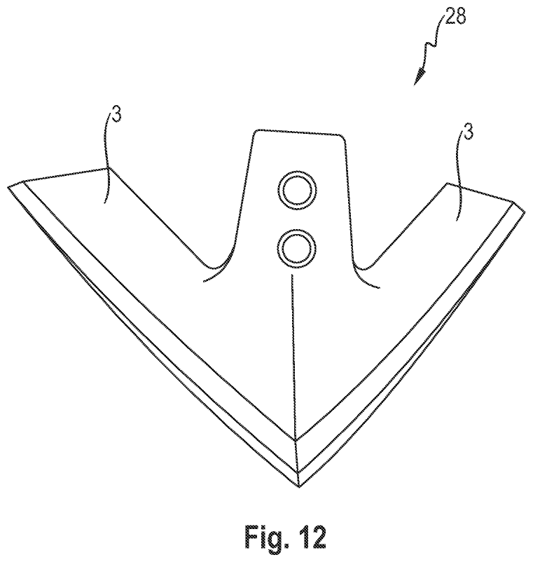

FIG. 12 illustrates a so-called duckfoot tine 28 that may be used instead of a second cutting element 3 having a two-winged design. Such a duckfoot tine 28 is customary, and may be manufactured at lower cost than a two-winged second cutting element 3 to be specially designed and manufactured. In this way, in a manner of speaking two ground areas 12 of the soil ridge 12 may be cut, in particular ground areas that are associated with the two leading hollow disc-like first cutting elements 4.

1. A turning plowing device with blade-like cutting elements situated on both sides of a plow beam, comprising: at least one first cutting element on one side, having a hollow disc-like design, having an adjustable cutting angle, is swiveled from a first position on a first side of the plow beam, in which the first cutting element is situated with respect to the blade-like second cutting elements, having an adjustable setting angle, in such a way that in each case a second cutting element and the first cutting element together form a complete module for plowing in a plowing direction, into a second position, on a second side opposite from the first side of the plow beam, by means of a swivel arm, in which the second cutting element as a semi-module in each case forms a complete module after the first cutting element is swiveled around, the complete module on the second side being turnable toward the ground in such a way that for a reverse plowing direction opposite the plowing direction, the ground is plowable with the same camber angle and cutting angle of the first cutting element.

2. The turning plowing device according to claim 1, comprising multiple hollow disc-like first cutting elements connected to one another via a rod assembly [[(8)]], and at the same time are swivelable from the first position into the second position by means of the respective swivel arm.

3. The turning plowing device according to claim 1, comprising multiple hollow disc-like first cutting elements individually swivelable by equal angles from the first position into the second position by means of respective hydraulic cylinders.

4. The turning plowing device according to claim 1, wherein the first cutting element is designed in such a way that when it is moved in the plowing direction, a side area of a soil ridge is cuttable from the ground, and the second cutting element is designed in such a way that due to its movement in the plowing direction a base area of the soil ridge is cuttable, the first cutting elements which are swivelable from the first side of the plow beam to the second side having equal cutting angles and camber angles in both the first position and the second position, and for turning by 180° the plow beam being rotatable about a plow tower turning unit.

5. The turning plowing device according to claim 4, wherein during swiveling of 77.3° by the swivel arms from the first position into the second position or vice versa, the cutting angle and the camber angle are equal.

6. The turning plowing device according to claim 1, wherein the swivel arm is lockable in a desired position.

7. The turning plowing device according to claim 1, wherein the blade-like second cutting elements are adjustable at the plow beam with regard to their cutting angle for penetration depth control, in particular by means of hydraulic actuators.

8. The turning plowing device according to claim 1, wherein the blade-like second cutting elements are fastened to the plow beam and are mechanically adjustable with regard to their cutting angle for penetration depth control, in particular via a perforated plate with shear bolts.

9. The turning plowing device according to claim 1, wherein the first cutting elements are swivelable in a first swivel direction by 270° to 300° about a swivel axis, or in a second swivel direction opposite the first swivel direction are swivelable by 80° to 100°, the swivel axis being situated at 90° with respect to the pull line of the plowing device.

10. The turning plowing device according to claim 9, wherein the hollow disc-like first cutting elements are swivelable in a plane.

11. The turning plowing device according to claim 1, wherein the first cutting elements are swivelable via a swivel lever and are lockable in the respective position.

12. The turning plowing device according to claim 1, wherein a second cutting element is situated behind only every other first cutting element.
